(19) United States
(12) Patent Application Publication
(10) Pub. No.: US 2009/0126762 A1
(43) Pub. Date: May 21, 2009

(54) CLEANING AND DRYING APPARATUS AND A CLEANING AND DRYING METHOD

(75) Inventors: Michinao NOMURA, Kawasaki (JP); Mitsuru KUBO, Kawasaki (JP); Chujiro FUKASAWA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/186,109

(22) Filed: Aug. 5, 2008

(30) Foreign Application Priority Data
Nov. 16, 2007 (JP) 2007-298135

(51) Int. Cl. B08B 7/00; B08B 13/00

(52) U.S. Cl. 134/18; 134/56 R

(57) ABSTRACT

A cleaning and drying apparatus includes a cleaning and drying tank where an organic solvent is stored, a resupplying part configured to resupply the organic solvent in the cleaning and drying tank when a storage amount of the organic solvent in the cleaning and drying tank is equal to or less than a designated value, and a installing and uninstalling apparatus configured to install and uninstall a cleaning and drying subject in a vapor area where vapor of the organic solvent is generated.

### BACKGROUND OF THE INVENTION

1. Field of the Invention

The present invention generally relates to cleaning and drying apparatus and cleaning and drying method, and more specifically, to a cleaning and drying apparatus and a cleaning and drying method wherein a cleaning and drying subject is provided in a vapor area of an organic agent and a cleaning and drying process is applied to the subject.

2. Description of the Related Art

It is general practice that, in a manufacturing process of an electronic component such as a magnetic head or a wafer, wet cleaning is implemented using a cleaning apparatus such as an ultrasonic wave cleaning apparatus applied between successive manufacturing processes, so that a deposit such as an adhesive adhered to the electronic component during the manufacturing processes is removed. In addition, after the cleaning process, a receiving case where the electronic component is received is provided in a cleaning and drying apparatus so that a surface of the electronic component is dried. See Japan Laid-Open Patent Application Publication No. 11-40536.

FIG. 1 is a schematic view of a related art cleaning and drying apparatus (hereinafter “vapor drying apparatus”) described in Japan Laid-Open Patent Application Publication No. 11-40536. A vapor drying apparatus 1 shown in FIG. 1 includes an apparatus main body 2, an elevating stage 8, a solvent discharge part 9, and others. The apparatus main body 2 forms the outer shape of the apparatus. The elevating stage 8, the solvent discharge part 9, and others are provided inside the apparatus main body 2. The elevating stage 8 is configured to support a receiving case 10. The receiving case 10 is configured to receive a cleaning subject (an electronic component such as a magnetic head or a wafer). The solvent discharge part 9 is configured to receive cleaning liquid such as water replaced with an organic solvent on a surface of the receiving case 10.

FIG. 2 shows the receiving case 10 for a magnetic head. As shown in FIG. 2, plural magnetic heads as row bars 11 are provided in the receiving case 10. Both ends (upper end and lower end) of each row bar 11 are held by the frame-shaped receiving case 10. A part situated between the ends of the row bar 11 is exposed from the receiving case 10. With this structure, as discussed below, droplets of the organic solvent can condense on the surfaces of the row bars (magnetic head) 11.

The organic solvent 3 fills a lower part of the apparatus main body 2. A heater 4 is provided under the organic solvent 3. When the heater 4 is operated, the organic solvent 3 is vaporized so that a vapor area 5 is formed. In addition, a cooling pipe 6 is provided inside an upper end of the apparatus main body 2. The snake-shaped cooling pipe 6 is configured to circulate cooling water inside. By circulating the cooling water inside the cooling pipe 6, a cooling area 7 is formed in the apparatus main body 2. In the cooling area 7, vapor of the organic solvent 3 heated by the heater 4 is cooled and liquefied so as to form dribbles. With this structure, vapor is prevented from being discharged outside the apparatus main body 2 and lost.

In the above-discussed vapor drying apparatus 1, when the receiving case (a cleaning and drying subject) 10 having a low temperature is provided in the apparatus main body 2 that is filled with high temperature vapor of an organic solvent, the droplets of the organic solvent condense on the surface of the electronic component received in the receiving case 10. As a result of this, the organic solvent flows down with dirt previously adhered on the surface of the electronic component, so that the surface of the electronic component is cleaned. After that, when the temperature of the receiving case 10 becomes equal to the temperature of the vapor, the organic solvent on the surface of the receiving case 10 is vaporized and dried. However, in the above-discussed cleaning and drying method, the cleaning effect on the surface of the electronic component is low and therefore stains of the dirt may remain on the surface of the electronic component after the cleaning and drying process.

### SUMMARY OF THE INVENTION

Accordingly, embodiments of the present invention may provide a novel and useful cleaning and drying apparatus and a cleaning and drying method solving one or more of the problems discussed above.

More specifically, the embodiments of the present invention may provide a cleaning and drying apparatus and a cleaning and drying method whereby cleaning quality and cleaning efficiency of a subject of cleaning and drying can be improved.

One aspect of the embodiments of the present invention may be to provide a cleaning and drying apparatus, including: a cleaning and drying tank where an organic solvent is stored; a resupplying part configured to resupply the organic solvent in the cleaning and drying tank when a storage amount of the organic solvent in the cleaning and drying tank is equal to or less than a designated value; and a installing and uninstalling apparatus configured to install and uninstall a cleaning and drying subject in a vapor area where vapor of the organic solvent is generated; wherein a cleaning process and a drying process for the cleaning and drying subject are implemented in the vapor area of the cleaning and drying apparatus, wherein the cleaning and drying apparatus further includes a temperature detecting part configured to detect a temperature of the vapor area; and a first preventing part configured to prevent driving of the install and uninstall apparatus when the temperature of the vapor area is equal to or lower than a temperature at which droplets of the organic solvent can condense on a surface of the cleaning and drying subject.

Another aspect of the embodiments of the present invention may be to provide a cleaning and drying method, including a first step of cleaning and drying a cleaning and drying subject provided in a vapor area where vapor of an organic solvent is generated; and a second step of taking out the cleaning and drying subject from the vapor area, wherein transfer from the first step to the second step is prevented in a case where the temperature of the vapor area is equal to or lower than a temperature at which droplets of the organic solvent can condense on a surface of the cleaning and drying subject.

Other objects, features, and advantages of the present invention will become more apparent from the following detailed description when read in conjunction with the accompanying drawings.

### BRIEF DESCRIPTION OF THE DRAWINGS

FIG. 1 is a structural view of a related art vapor drying apparatus;

FIG. 2 is a schematic view of a receiving case;

FIG. 3 is a structural view of a cleaning and drying apparatus of an embodiment of the present invention;

FIG. 4 is a pipe system view of the cleaning and drying apparatus of the embodiment of the present invention;

FIG. 5 is a perspective view of an apparatus main body;

FIG. 6 is a perspective view of a control apparatus;

FIG. 7 is a perspective view of a tank unit;

FIG. 8 is a view for explaining a nozzle moving mechanism;

FIG. 9 is a schematic view of a receiving basket where receiving cases are provided;

FIG. 10 is a view showing a state where organic solvent is jetted from a jetting nozzle onto the receiving basket containing the receiving case;

FIG. 11 is a first view for explaining operations of the cleaning and drying apparatus of the embodiment of the present invention;

FIG. 12 is a second view for explaining the operations of the cleaning and drying apparatus of the embodiment of the present invention;

FIG. 13 is a third view for explaining the operations of the cleaning and drying apparatus of the embodiment of the present invention;

FIG. 14 is a fourth view for explaining the operations of the cleaning and drying apparatus of the embodiment of the present invention;

FIG. 15 is a fifth view for explaining the operations of the cleaning and drying apparatus of the embodiment of the present invention;

FIG. 16 is a sixth view for explaining the operations of the cleaning and drying apparatus of the embodiment of the present invention;

FIG. 17 is a first flowchart showing a cleaning and drying process implemented by the control apparatus;

FIG. 18 is a second flowchart showing a cleaning and drying process implemented by the control apparatus;

FIG. 19 is a table showing an effect achieved by the cleaning and drying apparatus of the embodiment of the present invention;

FIG. 20 is a graph showing temperature change of a vapor area at a cleaning and drying process implementing time by the cleaning and drying apparatus of the embodiment of the present invention; and

FIG. 21 is a flowchart of a resupplying process of the organic solvent implemented by the control apparatus.

### DETAILED DESCRIPTION OF THE PREFERRED EMBODIMENTS

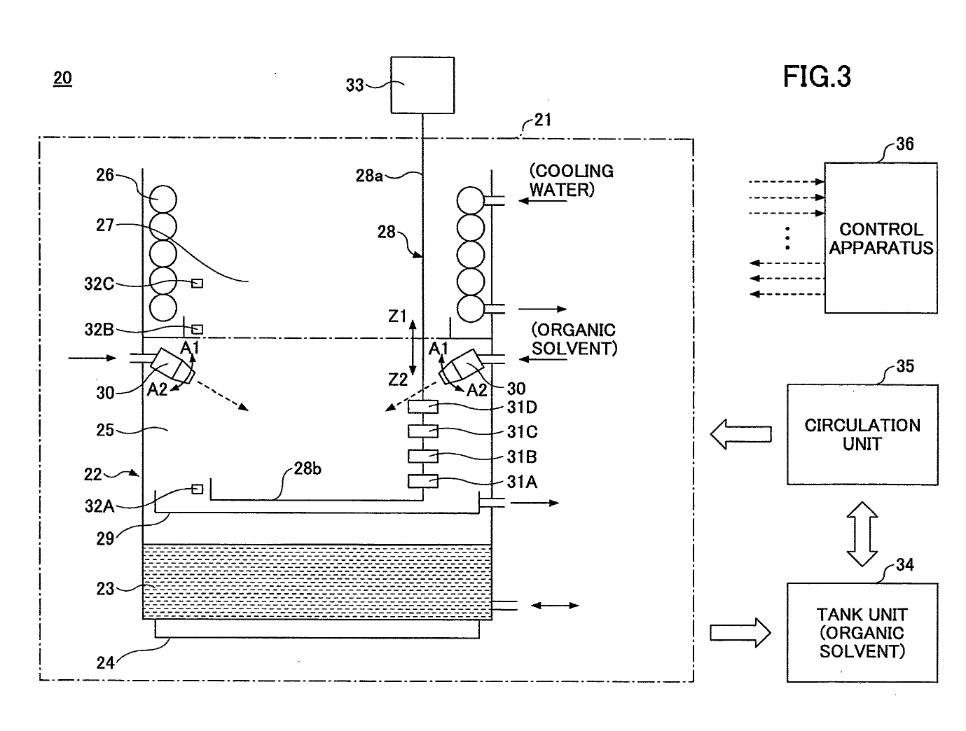

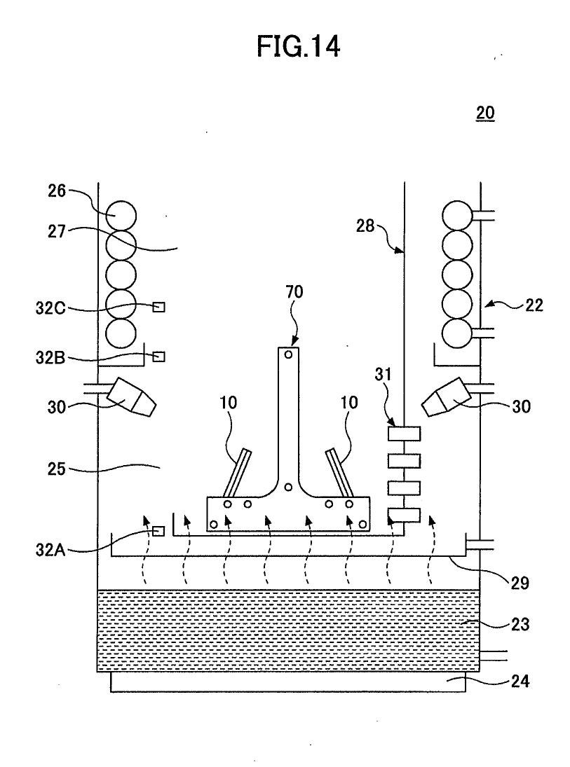

A description is given below, with reference to FIG. 3 through FIG. 21 of embodiments of the present invention.

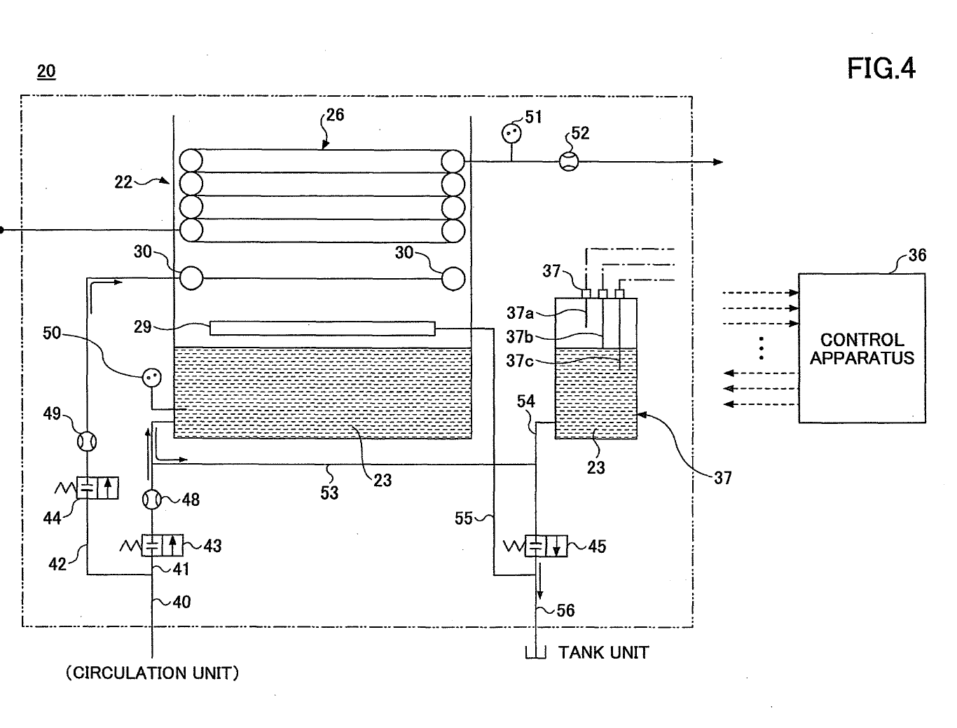

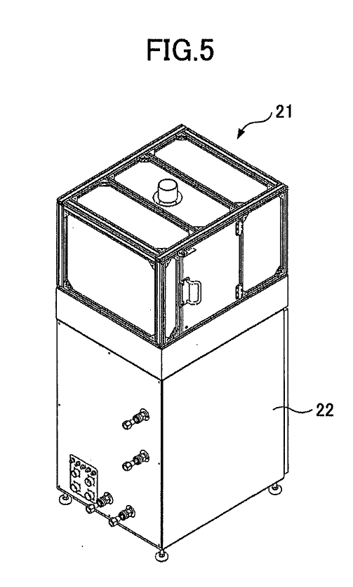

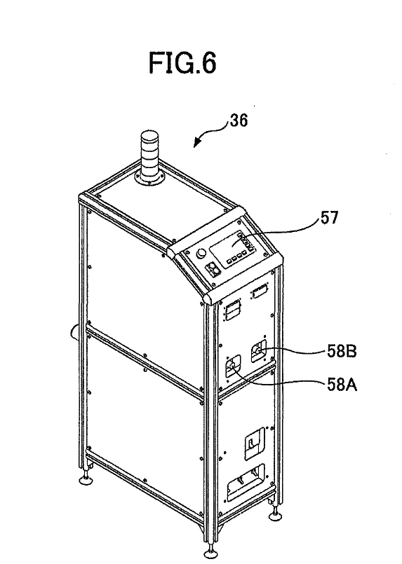

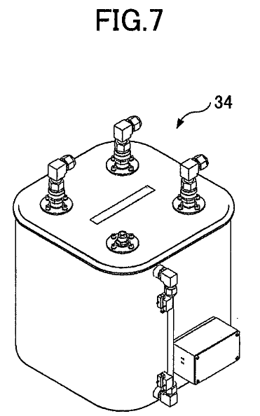

FIG. 3 through FIG. 7 are views for explaining the entire structure of a cleaning and drying apparatus 20 of an embodiment of the present invention. More specifically, FIG. 3 is a structural view of a cleaning and drying apparatus 20. FIG. 4 is a pipe system view of the cleaning and drying apparatus 20. FIG. 5 is a perspective view of an apparatus main body 21. FIG. 6 is a perspective view of a control apparatus 36. FIG. 7 is a perspective view of a tank unit 34.

First, the entire structure of the cleaning and drying apparatus 20 is discussed with reference to FIG. 3. The cleaning and drying apparatus 20 includes the apparatus main body 21, the tank unit 34, a circulation unit 35, and the control apparatus 36. The tank unit 34 shown in FIG. 7 accumulates an organic solvent 23 supplied to the apparatus main body 21. In addition, the circulation unit 35 circulates the organic solvent 23 between the apparatus main body 21 and the tank unit 34.

The apparatus main body 21 includes a cleaning and drying tank 22, a heater 24, cooling pipes 26, an elevating stage 28, a solvent receiving part 29, and jetting nozzles 30.

Approximately 10 L of the organic solvent 23 can be stored in the cleaning and drying tank 22 shown in FIG. 5. In this example, IPA (isopropyl alcohol) is used as the organic solvent 23.

The heater 23 as a heating part is provided on the bottom surface of the cleaning and drying tank 22. A temperature sensor is provided at the heater 24. The temperature sensor is configured to monitor the heating temperature. The organic solvent 23 in the cleaning and drying tank 22 is always heated by the heater 24 so that vapor of the organic solvent 23 is generated and a vapor area 25 is formed in the cleaning and drying tank 22. The temperature of the vapor area 25 is, for example, approximately 80° C.

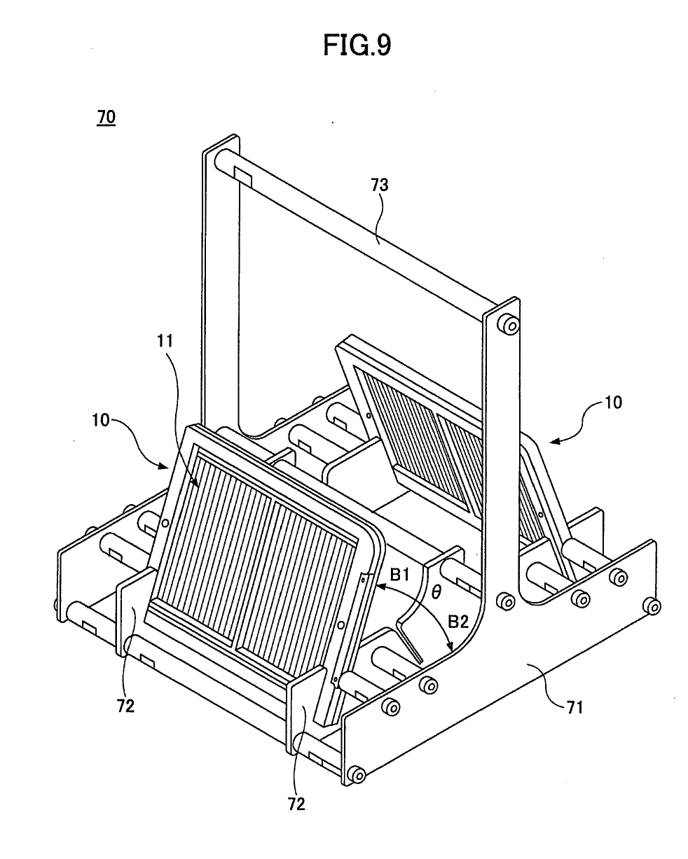

When driven by an elevation driving apparatus 33, the elevating stage 28 can move in upper and lower directions (direction indicated by arrows Z1 and Z2 in FIG. 3) in the cleaning and drying tank 22. The elevating stage 28 includes an arm part 28a and a stage part 28b. The arm part 28a is connected to the elevation driving apparatus 33. A receiving basket 70 discussed below shown in FIG. 9 is provided in the stage part 28b. The elevating stage 28 and the elevation driving apparatus 33 form an installing and uninstalling apparatus mentioned in claims below.

The elevation driving apparatus 33 is formed by a motor and rack and pinion or the like configured to convert rotational movement of the motor to a linear movement (not shown in FIG. 3) The arm part 28a of the elevating stage 28 is connected to the rack and pinion so that the stage part 28b is elevated by driving the elevation driving apparatus 33.

The receiving basket 70 (see FIG. 9) discussed below is provided at the elevating stage 28. Four temperature sensors 31A, 31B, 31C, and 31D are provided in upper and lower directions (Z1 and Z2 directions) and in the vicinity of a position where the receiving basket 70 is provided. The temperature sensors 31A, 31B, 31C, and 31D are configured to detect temperature distribution in the vapor area 25. The temperature sensors 31A, 31B, 31C, and 31D are connected to the control apparatus 36. The control apparatus 36 is configured to calculate a temperature in the vapor area 25 based on temperature detection signals from the temperature sensors 31A, 31B, 31C, and 31D.

The temperature sensors 31A, 31B, 31C, and 31D form a temperature detecting part mentioned in claims below. In addition, it is not always necessary to provide the temperature sensors 31A, 31B, 31C, and 31D at the elevating stage 28. The temperature sensors 31A, 31B, 31C, and 31D may be provided in other positions as long as the temperature distribution of the vapor area 25 can be measured. For example, the temperature sensors 31A, 31B, 31C, and 31D may be directly provided at the cleaning and drying tank 22.

The elevating stage 28 moves between a providing/receiving position and a cleaning and drying position. Here, the providing/receiving position is where the receiving basket 70 is provided or received at the stage part 28b. The cleaning and drying position is where the cleaning and drying process is applied to a cleaning and drying subject provided in the receiving basket 70. The providing/receiving position is situated in an upper part of the cleaning and drying tank 22. In addition, the cleaning and drying position is situated in lower part of the cleaning and drying tank 22 near the organic solvent 23.

Therefore, it is necessary to prevent elevating operations of the elevating stage 28 in the providing/receiving position and the cleaning and drying position. Because of this, a position sensor 32A is provided in the cleaning and drying position in the cleaning and drying tank 22 and a position sensor 32C is provided in the providing/receiving position of the cleaning and drying tank 22. Each of the position sensors 32A and 32C is connected to the control apparatus 36. Therefore, the control apparatus 36 detects, based on output signals of the position sensors 32A and 32C, when the stage part 28b (receiving basket 70) reaches the providing/receiving position and the cleaning and drying position.

In addition, a position sensor 32B is provided between the position sensors 32A and 32C. As discussed below, when the elevating stage 28 is elevated, the elevating velocity is switched. The position sensor 32B is provided in this velocity switching position. The position sensor 32B is connected to the control apparatus 36. Accordingly, based on the output from the position sensor 32B, the control apparatus 36 detects when the elevating stage 23 reaches the velocity switching position.

The jetting nozzles 30 are configured to jet the organic solvent 23. The organic solvent 23 is supplied from the tank unit 34 to the jetting nozzles 30 by the circulating unit 35. Although two jetting nozzles 30 are provided in the cleaning and drying tank 22 so as to face to each other in this example, positions and the number of the jetting nozzles 30 are not limited to this example.

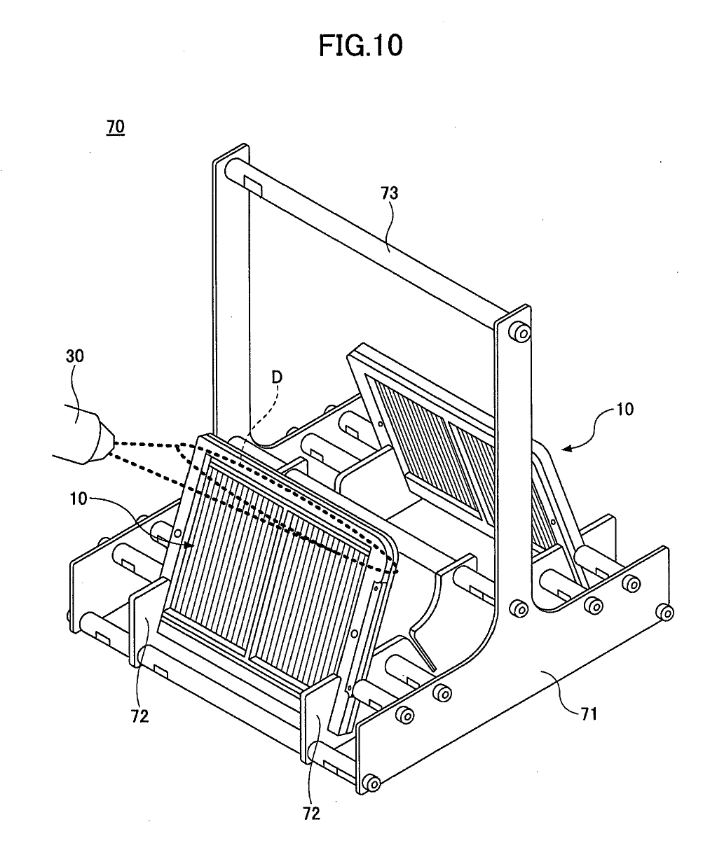

The jetting nozzle 30 jets the organic solvent 23 to the receiving basket 70 when the elevating stage 23 is in the cleaning and drying position. In this example, by making the jet opening of the jetting nozzle 30 have a flat configuration, as shown in FIG. 10, a receiving part of the receiving case 10 (row bars 11) where the organic solvent 23 is jetted has an elliptical-shaped configuration. Since the receiving case 10 has a rectangular-shaped configuration, with this structure, it is possible to jet the organic solvent 23 onto the receiving case 10 more efficiently than a case where the jet receiving part has a circular-shaped configuration.

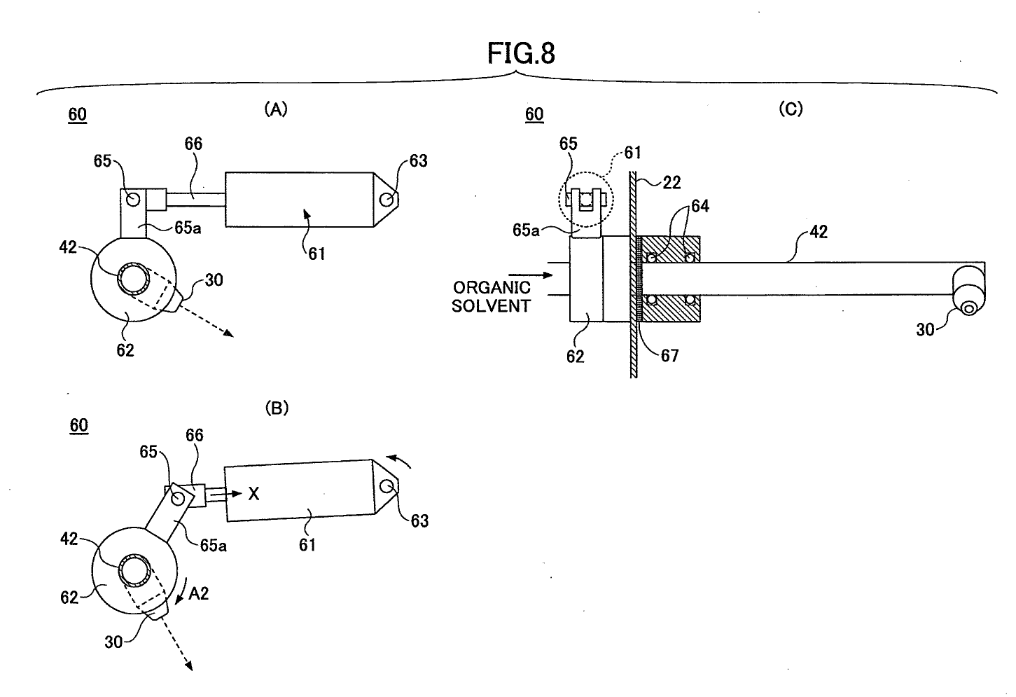

In addition, in this example, in order to improve the jetting efficiency of the organic solvent 23 onto the receiving basket 70, the jetting nozzles 30 can be moved (rotated) in directions indicated by arrows A1 and A2 in FIG. 3. A nozzle moving mechanism 60 configured to move the jetting nozzle 30 is discussed with reference to FIG. 8. FIG. 8(A) is a side view of the nozzle moving mechanism 60. FIG. 8(B) is a view for explaining operations of the nozzle moving mechanism 60. FIG. 8(C) is a front view of the nozzle moving mechanism 60.

The nozzle moving mechanism 60 includes a cylinder 61, a rotational block 62, a connecting part 65, and others. A right end part in FIG. 8(A) of the cylinder 61 is pivotably connected to a rotational fulcrum 63 providing at the cleaning and drying tank 22. The cylinder 61 driving is controlled by the control apparatus 36. By the driving of the cylinder 61, a shaft 66 linearly moves.

The rotational block 62 is rotatably connected to the cleaning and drying tank 22. A jetting pipe 42 is coaxially connected to the rotational block 62. The jetting pipe 42 is provided so as to pierce the cleaning and drying tank 22. The jetting nozzle 30 is provided at an end part of the jetting pipe 42 inside the cleaning and drying tank 22. An end part of the jetting pipe 42 outside the cleaning and drying tank 22 is connected to the circulation unit 35 so that the organic solvent 23 is supplied. The jetting nozzle 30 is provided at a head end part of the jetting pipe 42.

An arm part 65a extending toward the outside is provided at the rotational block 62. The head end part of the arm part 65a is connected to the shaft 66 via the connecting part 65. Accordingly, when the cylinder 61 is driven, the jetting pipe 42 is rotated via the rotational block 62 so that the jetting nozzle 30 is moved in the direction indicated by the arrows A1 and A2 in FIG. 3. For example, as shown in FIG. 8(B), when the shaft 66 of the cylinder 61 moves in a direction indicated by an arrow X, the rotational block 62 is rotated clockwise with respect to the jetting pipe 42 via the connecting part 65, so that the jetting nozzle 30 is moved (rotated) in the direction indicated by the arrow A2.

As discussed above, by properly setting the configuration of the jet opening of the jetting nozzle 30, a part of the receiving case 10 (row bars 11) where the organic solvent 23 is jetted can have an elliptical-shaped configuration. In addition, by setting the jetting nozzle 30 rotatably in the directions indicated by the arrow A1 and A2, it is possible to jet the organic solvent 23 efficiently onto the receiving case 10 (row bar 11) so that cleaning efficiency can be improved.

O-shaped rings 64 and a packing 67 are provided in a position where the jetting pipe 42 pierces the cleaning and drying tank 22. Hence, the vapor of the organic solvent 23 does not leak from this position to outside of the apparatus main body 21.

Referring back to FIG. 3, the solvent receiving part 29 is provided above the liquid surface of the organic solvent 23 and below the above-discussed cleaning and drying apparatus. The solvent receiving part 29 is configured to receive the organic solvent 23 dropped from the receiving basket 70 (row bars 11) at the time of the cleaning and drying process and the organic solvent 23 jetted from the jetting nozzles 30. The received organic solvent 23 returns to the tank unit 34 after the cleaning process is implemented.

The cooling pipes 26 are provided in an upper position where the jetting nozzles 30 in the cleaning and drying tank 22 are provided. Cooling water is always supplied from a cooling water supplying apparatus (not shown) to the cooling pipes 26. Accordingly, a cooling area 27 is formed inside between the cooling pipes 26 facing each other. The vaporized organic solvent 23 is liquefied in the cooling area 27 and drops. Because of this, it is possible to prevent the vapor of the organic solvent 23 from leaking outside the cleaning and drying tank 22 and prevent the organic solvent 23 from being reduced.

The control apparatus 36 is connected to the sensors 31A through 31D and 32A through 32C and various kinds of sensors provided at a pipe system discussed below. Based on signals from these sensors, a cleaning and drying control process and a process for resupplying the organic solvent 23 to the cleaning and drying tank 22 are implemented. FIG. 6 shows the external appearance of the control apparatus 36. As shown in FIG. 6, the control apparatus 36 includes an input panel 57, velocity input switches 58A and 58B, and others.

Next, the receiving basket 70 configured to receive the row bars 11 (the cleaning and drying subject) is discussed. FIG. 9 is a perspective view of the receiving basket 70. The receiving basket 70 includes a basket main body 71, a case attaching part 72, a grip part 73, and others.

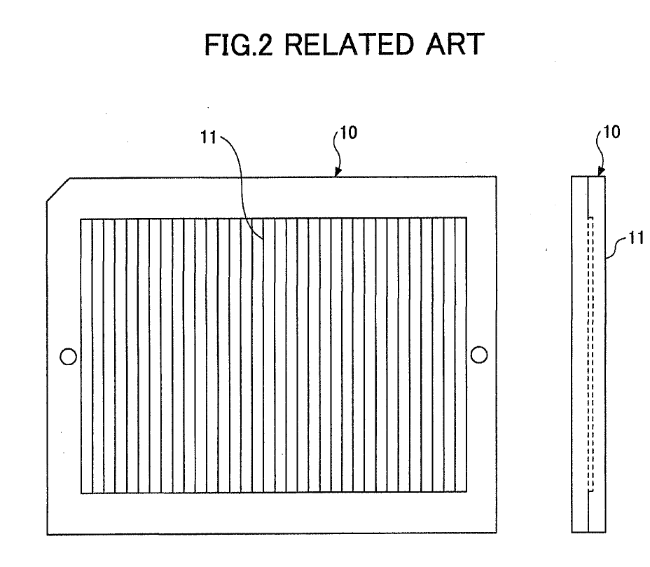

The basket main body 71 is mounted on the stage part 28b of the elevating stage 28. In this example, two receiving cases 10 are attached. As discussed with reference to FIG. 2, the receiving case 10 has a frame-shaped configuration. Plural stick-shaped row bars 11 are provided inside the receiving case 10. Both ends of each row bar 11 are held by the frame-shaped receiving case 10 and a part between the ends of the row bar 11 is exposed from the receiving case 10.

The row bar 11 is formed of plural magnetic heads arranged in a line diced from a wafer. By further dicing the row bar 11, individual magnetic heads are manufactured.

The case attaching part 72 configured to attach the receiving case 10 is provided in the basket main body 71. The case attaching part 72 can hold the receiving case 10 at an angle θ with respect to the basket main body 71. In this example, the angle between the receiving case 10 and the case attaching part 72 is approximately 70 degrees. Thus, by optionally setting the angle between the receiving case 10 and the case attaching part 72, it is possible to jet the organic solvent 23 from the jetting nozzle 30 onto the row bar 11 (magnetic head) at a substantially right angle, so that the cleaning efficiency can be improved.

The grip part 73 is griped by an operator when the receiving basket 70 is being installed in or uninstalled from the elevating stage 28. Thus, because of the grip part 73, it is possible to easily install and uninstall the receiving basket 70 in and from the elevating stage 28 within a short period of time.

Next, the pipe system of the cleaning and drying apparatus 20 is discussed with reference to FIG. 4.

An end part of an upstream side of flow of the organic solvent 23 of a supply pipe 40 is connected to the circulation unit 35. An end part of a downstream side of the flow of the organic solvent 23 of the supply pipe 40 is in communication with the organic solvent 23 stored at a lower part of the cleaning and drying tank 22. The organic solvent 23 stored in the tank unit 34 is supplied to the supply pipe 40 by the circulation unit 35.

The supply pipe 40 forks so that a resupplying pipe 41 and a jetting pipe 42 are formed. A valve 43 and a flow rate sensor 48 are provided at the resupplying pipe 41 from the upstream side. The valve 43 is an electromagnetic valve whose driving is controlled by the control apparatus 36. The flow rate sensor 48 is configured to detect a flow rate of the organic solvent 23 flowing in the supply pipe 40 when the valve 43 is open. In addition, a communicating pipe 53 as a bifurcation pipe is provided between the flow rate sensor 48 and a position where the supply pipe 40 and the cleaning and drying tank 22 are connected. The communicating pipe 53 is connected to a liquid surface sensor pipe 54.

The jetting nozzle 30 is provided at a down stream side end part of the jetting pipe 42. A valve 44 and a flow rate sensor 49 are provided on the way to the jetting nozzle 30 in the jetting pipe 42.

The valve 44 is an electromagnetic valve whose driving is controlled by the control apparatus 36. The flow rate sensor 49 is configured to detect the flow rate of the organic solvent 23 jetted from the jetting nozzle 30 when the valve 44 is tuned on. The valves 43 and 44 are normally closed valves. Until opening valve signals are supplied from the control apparatus 36 to the valves 43 and 44, supply of the organic solvent 23 from the circulation unit 35 to the resupplying pipe 41 and the jetting pipe 42 is stopped.

The liquid surface sensor pipe 54 and a receiving pipe 55 are connected to each other so as to form a discharge pipe 56. A downstream side end part of the discharge pipe 56 is connected to the tank unit 34. A liquid surface sensor 37 is provided at an upstream side of the liquid surface sensor pipe 54.

A valve 45 is provided between the liquid surface sensor 37 and a position where the liquid surface sensor pipe 54 and the discharge pipe 56 are connected to each other. The valve 45 is an electromagnetic valve whose driving is controlled by the control apparatus 36. The valve 45 is a normally closed valve. Until an opening valve signal is supplied from the control apparatus 36 to the valve 45, discharge of the organic solvent 23 stored in the cleaning and drying tank 22 from the apparatus main body 21 is stopped.

The liquid surface sensor 37 is configured to detect the liquid surface of the organic solvent 23 stored in the lower part of the cleaning and drying tank 22. In a state where the valves 43 and 45 are closed, the cleaning and drying tank 22 and the liquid sensor 37 are in communication with each other via the communication pipe 53. Therefore, the height of the liquid surface of the organic solvent 23 in the cleaning and drying tank 22 is equal to the height of the liquid surface of the organic solvent 23 in the liquid sensor 37.

Detecting parts 37a through 37c are provided in the liquid surface sensor 37 and connected to the control apparatus 36. Positions where the liquid surfaces are detected by the detecting parts 37a through 37c are different from each other. Accordingly, the control apparatus 36 can detect the height of the liquid surface of the organic solvent 23 in the cleaning and drying tank 22, namely the storage amount of the organic solvent 23 in the cleaning and drying tank 22, based on detection signals from the liquid sensor 37 (detecting parts 37a through 37c).

A temperature sensor 50 is provided in a position of the cleaning and drying tank 22 where the organic solvent 23 is stored. The temperature sensor 50 is configured to detect the temperature of the organic solvent 23 in the cleaning and drying tank 22. The temperature of the organic solvent 23 detected by the temperature sensor 50 is transmitted to the control apparatus 36.

On the other hand, the cooling pipes 26 are connected to a cooling water supply opening of a factory where the magnetic heads are manufactured and where the cleaning and drying apparatus 20 is provided. A temperature sensor 51 for monitoring the temperature and a flow rate sensor 52 for monitoring the flow rate are provided at the cooling pipes 26.

In the cleaning and drying apparatus 20 having the above-mentioned structure, in order to jet the organic solvent 23 from the jetting nozzles 30, the valve 43 is closed and the valve 44 is opened. As a result of this, the organic solvent 23 having a high pressure and supplied from the circulation unit 35 to the supplying pipes 40 passes through the jetting pipe 42 so as to be jetted from the jetting nozzle 30.

In addition, when it is found, by liquid surface detection by the liquid surface sensor 37, that the storage amount of the organic solvent 23 in the cleaning and drying tank 22 is reduced, the valves 44 and 45 are closed and the valve 43 is opened. As a result of this, the organic solvent 23 having a high pressure and supplied from the circulation unit 35 to the supplying pipe 40 passes through the resupplying pipe 41 so as to flow in the cleaning and drying tank 22. Hence, the storage amount of the organic solvent 23 in the cleaning and drying tank 22 is increased.

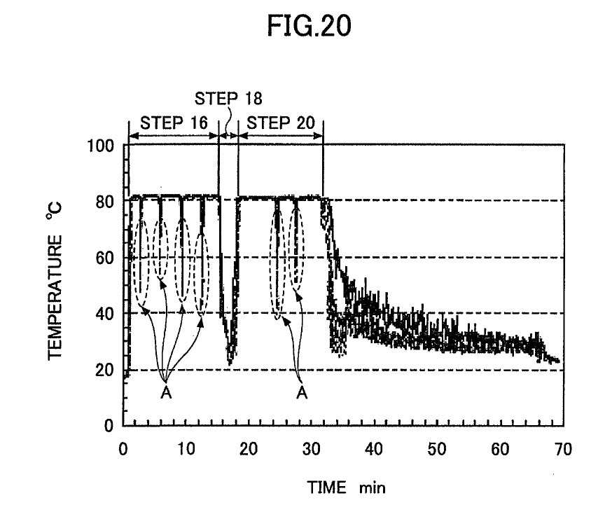

Since the organic solvent 23 flowing in the cleaning and drying tank 22 is not heated, the temperature of the organic solvent 23 in the cleaning and drying tank 22 is decreased for a designated time after flow-in so that the temperature of the vapor area 25 is decreased and lower than a normal temperature (approximately 80° C. in this example). This is discussed with reference to FIG. 20.

FIG. 20 is a graph showing temperature change of the vapor area 25 at a cleaning and drying process implementing time. The decrease of the temperature in the vapor area 25 indicated by arrows A in FIG. 20 is generated by resupplying the organic solvent 23 in the cleaning and drying tank 22.

Thus, when the temperature in the vapor area 25 is drastically decreased for a while based on the resupplying of the organic solvent 23 so as to be equal to or lower than the temperature at which the droplets of the organic solvent 23 condense, the droplets of the organic solvent 23 may condense on the surface of the row bar 11 which is the cleaning and drying subject. If the row bar 11 (receiving case 10) is taken out from the organic solvent 21 in a state where the droplets of the organic solvent 23 is generated, stains due to condensation may be generated on the surface of the row bar 11.

On the other hand, when it is found, by liquid surface detection by the liquid surface sensor 37, the storage amount of the organic solvent 23 in the cleaning and drying tank 22 is increased, the valves 43 and 44 are closed and the valve 45 is opened. As a result of this, the organic solvent 23 stored in the cleaning and drying tank 22 is discharged to the tank unit 34 via the communicating pipe 53 and the discharge pipe 56. Hence, the storage amount of the organic solvent 23 in the cleaning and drying tank 22 is decreased.

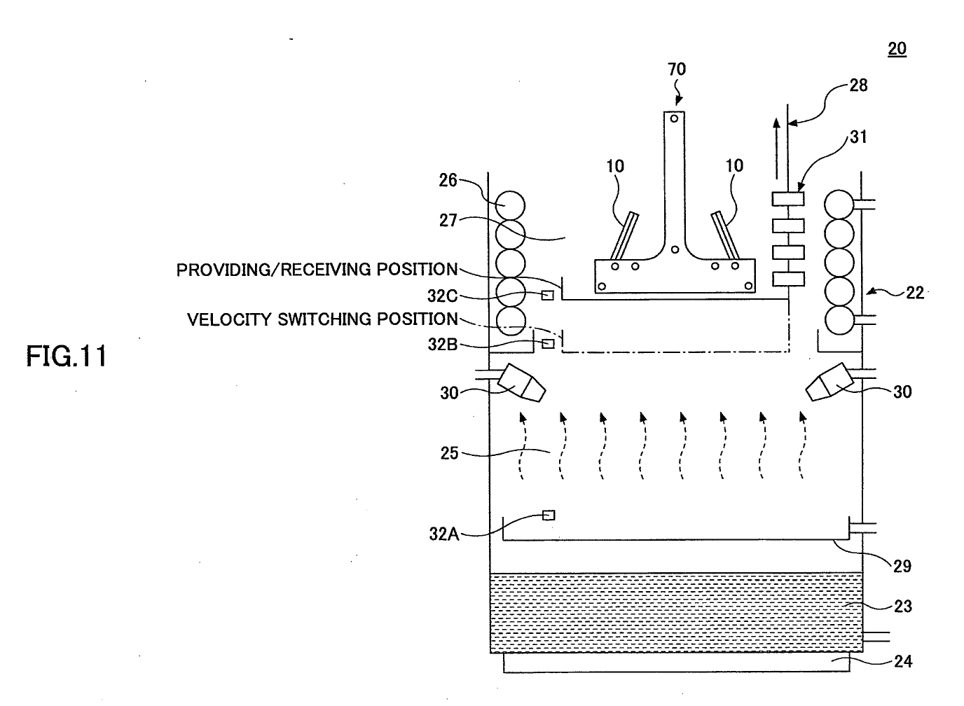

Next, operations of the cleaning and drying apparatus 20 at the cleaning and drying process time, the cleaning and drying process implemented by the control apparatus 36, and a process of resupplying the organic solvent 23 to the cleaning and drying apparatus 22 implemented by the control apparatus 36 are discussed with reference to FIG. 11 through FIG. 21.

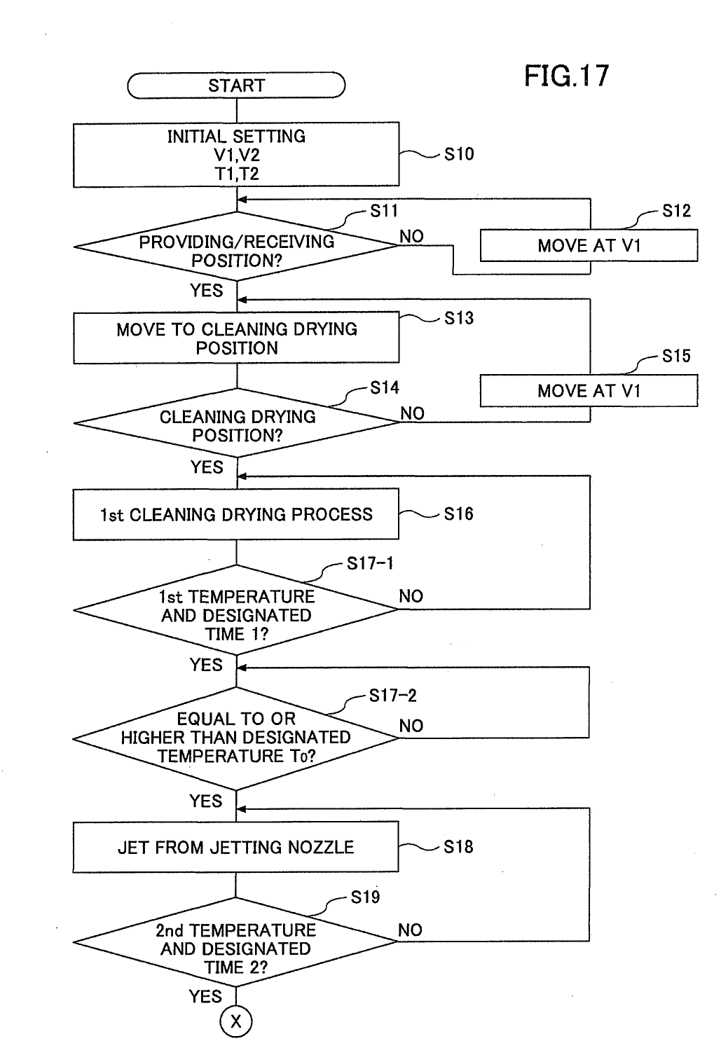

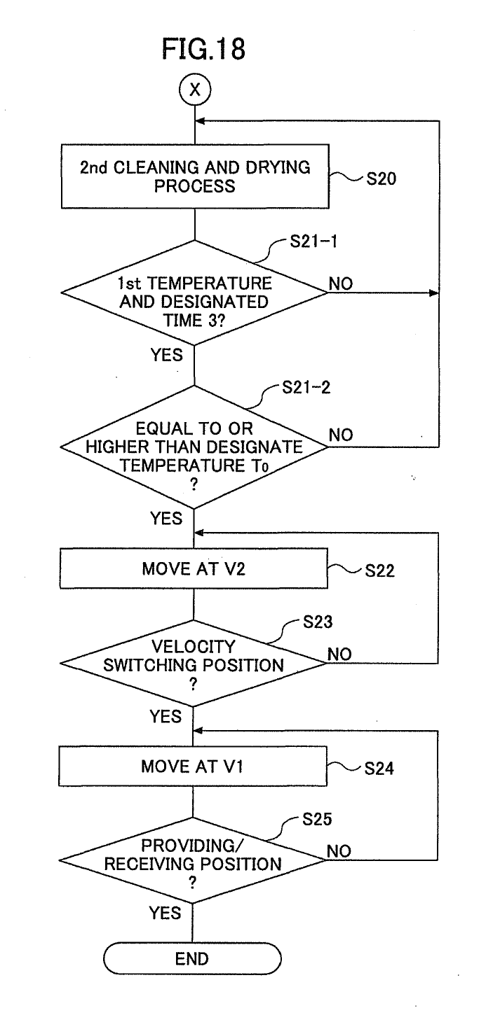

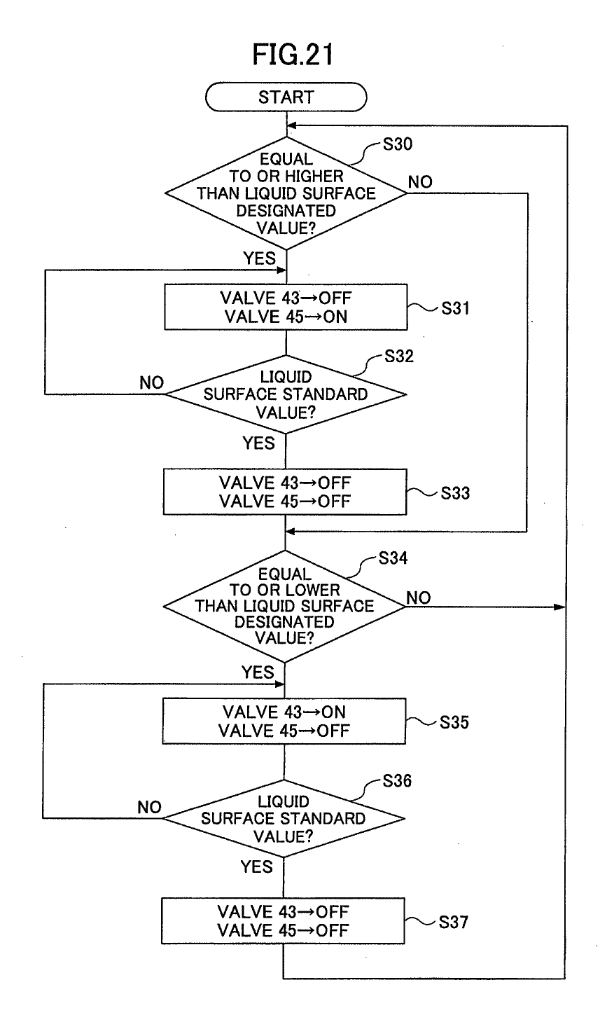

FIG. 11 through FIG. 16 are views for explaining the operations of the cleaning and drying apparatus 20. FIG. 17 and FIG. 18 are flowcharts showing the cleaning and drying process implemented by the control apparatus 36. FIG. 21 is a flowchart of a process of resupplying the organic solvent 23 into the cleaning and drying tank 22 implemented by the control apparatus 36. In FIG. 11 through FIG. 16, parts that are the same as the parts shown in FIG. 2 through FIG. 10 are given the same reference numerals, and explanation thereof is omitted.

After the cleaning and drying apparatus 20 starts working, the control apparatus 36 starts the cleaning and drying process and a process for resupplying the organic solvent 23. For the convenience of explanation, first, the process for resupplying the organic solvent 23 is discussed with reference to FIG. 21.

When the cleaning and drying apparatus 20 starts, in step S30, the control apparatus 38 determines whether the liquid surface of the organic solvent 23 stored in the cleaning and drying tank 22 is equal to or higher than a designated value based on the signal from the liquid surface sensor 37.

Here, the designated value in step S30 means the liquid surface height corresponding to the maximum storage amount in a range of proper storage amounts of the organic solvent 23 whereby vapor of the organic solvent 23 is properly generated in the vapor area 25. Just after the cleaning and drying apparatus 20 starts, the valves 43 and 45 which are normally closed valves are closed (OFF).

When it is determined in step S30 that the liquid surface has a value equal to or greater than the designated value, that is, when excessive organic solvent 23 is stored in the cleaning and drying tank 22, the process goes to a step S31, so that the control apparatus 36 opens (turns on) the valve 45 while the control apparatus 36 maintains the valve 43 closed (OFF). As a result of this, the organic solvent 23 in the cleaning and drying tank 22 is discharged to the tank unit 34 via the communicating pipe 53, the valve 45, and the discharge pipe 56. With this structure, the storage amount of the organic solvent 23 in the cleaning and drying tank 22 is reduced and the liquid surface of the organic solvent 23 goes down.

The control apparatus 36 maintains, in step S32, the valve 43 closed (OFF) and the valve 45 open (ON) until the height of the liquid surface of the organic solvent 23 reaches the standard value. Here, the standard value is a liquid surface height which is an average of a range of a proper storage amount of the organic solvent 23 whereby the vapor of the organic solvent 23 can be properly generated in the vapor area 25 (maximum storage amount and minimum storage amount).

On the other hand, if it is determined, in step S32, the height of the liquid surface of the organic solvent 23 is reduced to the designated value, the process goes to step S33 so that the valves 43 and 45 are closed (turned OFF). Because of the above process, if the amount of the organic solvent 23 in the cleaning and drying tank 22 is greater than the designated amount, the organic solvent 23 is controlled by the control apparatus 36 so as to become the designated amount.

On the other hand, if it is determined, in step S30, the height of the liquid surface of the organic solvent 23 in the cleaning and drying tank 22 is not equal to or greater than the designated value, the process goes to step S34. In step S34, based on signals from the liquid surface sensor 37, the control apparatus 36 determines whether the liquid surface of the organic solvent 23 stored in the cleaning and drying tank 22 has a value lower than the designated value.

Here, the designated value in step S34 means a liquid surface height corresponding to the minimum storage amount in a storage amount range of the organic solvent 23 whereby the vapor of the organic solvent 23 can be properly generated in the vapor area 25.

On the other hand, if it is determined, in step S34, the liquid surface of the organic solvent 23 in the cleaning and drying tank 22 is equal to or lower than the designated value, the process goes to step S35. In step S35, the control apparatus 36 opens (turns ON) the valve 44 while the control apparatus 36 maintains the valve 45 closed (OFF). As a result of this, the organic solvent 23 supplied from the circulation unit 35 is supplied to the cleaning and drying tank 22 via the supply pipe 40 and the resupplying pipe 41. With this structure, the organic solvent 23 is resupplied in the cleaning and drying tank 22 and the liquid surface of the organic solvent 23 goes up.

The control apparatus 36 maintains, in step S36, the valve 43 open (ON) and the valve 45 closed (OFF) until the height of the liquid surface of the organic solvent 23 reaches the standard value. On the other hand, if it is determined, in step S36, the height of the liquid surface of the organic solvent 23 is increased to the standard value, the process goes to step S37 so that the valves 43 and 45 are closed (turned OFF). Because of this, if the amount of the organic solvent 23 in the cleaning and drying tank 22 is smaller than the designated amount, the organic solvent 23 is controlled by the control apparatus 36 so as to retain the standard designated amount.

The processes of steps S30 through S37 are repeated during when the cleaning and drying apparatus 20 is driven.

Next, the cleaning and drying process implemented by the control apparatus 36 is discussed.

When the cleaning and drying process of the cleaning and drying apparatus 20 is started, the heater 24, the circulation unit 35, and the control apparatus 36 are started and supply of cooling water to the cooling pipe 26 is started. First, an initial setting of the control apparatus 36 is performed in step S10 in FIG. 17.

A first velocity V1, a second velocity V2, and a first temperature T1 and a second temperature T2 are set in step S10. The first velocity V1 is a velocity for lowering the elevating stage 28. The second velocity V2 is a velocity for raising the elevating stage 28. The first temperature T1 and the second temperature T2 are set so that timings of starting and stopping the jetting of the organic solvent 23 from the jetting nozzles 30 are determined. This setting process is implemented by the input panel 57 and the velocity input switches 58A and 58B shown in FIG. 6.

In this example, the first velocity V1 is, for example, 9.5 mm/s and the second velocity V2 is, for example, 2.5 mm/s. The first temperature T1 is substantially equal to the temperature in the vapor area 25, for example approximately 80° C. in this example. Furthermore, the second temperature T2 is the temperature at which droplets of the organic solvent 23 are generated on the surface of the receiving case 10 (row bar 11) provided in the vapor area 25, for example, approximately 24° C. in this example.

The first velocity V1, the second velocity V2, and the first temperature T1 and the second temperature T2 are changed depending on the kind of the organic solvent 23 to be used, the volume of the cleaning and drying tank 22, and kind or configuration of the receiving case 10 (row bar 11). The first velocity V1, the second velocity V2, and the first temperature T1 and the second temperature T2 are not limited to the above-discussed example.

When the initial setting is completed in step S10 as discussed above, the control apparatus 36 moves the elevating stage 28 to the providing/receiving position. More specifically, the control apparatus 36 detects the present position of the elevating stage 28 based on signals from the position sensors 32A through 32C in step S11. When the elevating stage 28 is not situated in the providing/receiving position, the elevation driving apparatus 33 is driven so as to move the elevating stage 28 to the providing/receiving position at the first velocity V1 in step S12.

When the elevating stage 28 moves to the providing/receiving position by the processes in step S11 and step S12, the receiving basket 70 where the receiving case 10 is received is provided on the elevating stage 28. FIG. 11 shows a state where the receiving basket 70 is provided on the elevating stage 28.

When the receiving basket 70 is provided on the elevating stage 28, in step S13 the control apparatus 36 drives the elevation driving apparatus 33 again so that the elevating stage 28 is moved to the cleaning and drying position at the first velocity V1. At this time, the velocity for lowering the elevating stage 28 is the first velocity V1. The control apparatus 36 keeps lowering the elevating stage 28 until the position sensor 32A provided at the cleaning and drying position detects the elevating stage 28, in step S14 and step S15.

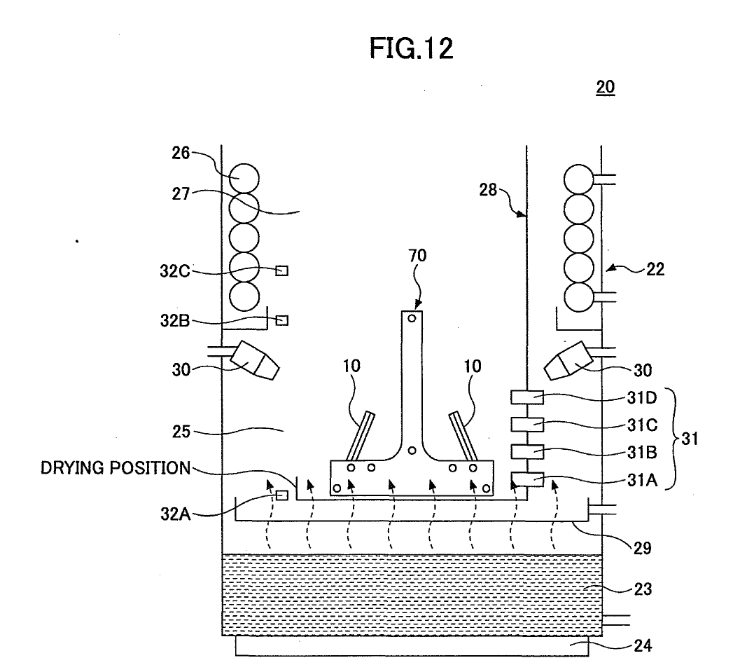

When it is determined by the position sensor 32A that the elevating stage 28 has reached to the cleaning and drying position, the control apparatus 36 prevents movement of the elevating stage 28. FIG. 12 shows a state where the elevating stage 28 reaches the cleaning and drying position.

When the elevating stage 28 reaches the cleaning and drying position, the row bar 11 which is the cleaning and drying subject is provided in the vapor area 25. Hence, a first cleaning and drying process is applied to the row bar 11 in step S16. At the same time when the elevating stage 28 reaches the cleaning and drying position, the control apparatus 36 starts measuring a first process time, namely a process time of the first cleaning and drying process.

In the first cleaning and drying process, the temperature of the row bar 11 provided in the vapor area 25 is, for example approximately 20° C. through approximately 25° C., lower than the temperature in the vapor area 25, approximately 80° C. Therefore, the droplets of the organic solvent 23 condense on the surface of the row bar 11. The condensed organic solvent 23 falls down on the surface of the row bar 11 and the dirt on the surface of the row bar 11 flows down concurrently. Hence, the surface of the row bar 11 is cleaned. In addition, when the temperature of the row bar 11 is increased with change of time, the droplets do not condense on the row bar 11 and the organic solvent 23 adhered on the surface of the row bar 11 is vaporized by heat. Thus, the surface of the row bar 11 is dried.

The control apparatus 36, in step S17-1, measures the temperature of the vapor area 25 with the temperature sensors 31A through 31D so as to detect the temperature of the row bar 11. Next, the control apparatus 36 determines whether the temperature of the row bar 11 is substantially equal to the first temperature set in step S10, namely the temperature in the vapor area 25.

In addition, the control apparatus 36 not only performs the above-mentioned temperature detecting process but also determines whether the first process time after the elevating stage 28 reaches the cleaning and drying position exceeds a designated time 1. Here, the “designated time 1” is a time obtained via experiment. The “designated time 1” is the time required for the temperature of the row bar 11 to become the first temperature after the row bar 11 is provided in the vapor area 25. In this example, the designated time is approximately 14 minutes.

When the temperature of the row bar 11 is equal to or lower than the first temperature and the process time after the row bar 11 is provided in the vapor area 25 does not exceed the designated time 1, the first cleaning process in step S16 continues.

On the other hand, if it is determined that the temperature of the row bar 11 exceeds the first temperature and the first process time exceed the designate time 1, the control apparatus 36 goes the process to step S17-2. In step S17-2, it is determined whether the temperature of the vapor area 25 measured by the temperature sensors 31A through 31D is equal to or higher than a designated temperature T₀. Here, the “designated temperature T₀” is a temperature where the droplets of the organic solvent 23 can condense on the surface of the receiving case 10 (row bar 11) when the receiving case 10 (row bar 11) which is a cleaning and drying subject is provided in the vapor area 25. In this example, “designated temperature T₀” is a upper limit of the temperature where the droplets of the organic solvent 23 can condense on the surface of the receiving case 10 (row bar 11).

In step S17-2, where the temperature of the vapor area 25 is less than the designated temperature T₀, the organic solvent 23 has been resupplied from the circulation unit 35 into the cleaning and drying tank 22 by the resupplying process of the organic solvent 23 discussed with reference to FIG. 21. At this time, since the organic solvent is not heated, the organic solvent 23 in the cleaning and drying tank 22 is reduced in temperature for a while so that the temperature of the vapor area 25 is also decreased. The decrease of the temperature in the vapor area 25 is indicated by an arrow A in FIG. 20. Accordingly, the temperature of the receiving case 10 (row bar 11) provided in the vapor area 25 is also decreased.

In this example, when the temperature of the vapor area 25 is lower than the designated temperature T₀, the process is prevented proceeding to step S18 where the organic solvent 23 is jetted from the jetting nozzle 30. By implementing step S17-2, it is possible to make the cleaning and drying process efficient.

In other words, one of the purposes of the process for jetting the organic solvent 23 from the jetting nozzle 30 onto the receiving case 10 (row bar 11) is reduction of the temperature of the receiving case 10 (row bar 11) which has been increased in the vapor area 25. Accordingly, even if the organic solvent 23 is jetted from the jetting nozzle 30 onto the receiving case 10 (row bar 11) in a state where the temperature of the vapor area 25 is decreased so that the temperature of the receiving case 10 (row bar 11) is decreased, efficiency of the cleaning and drying process is not high. However, in this example, when the temperature of the vapor area 25 is lower than the designated temperature T₀, jetting of the organic solvent 23 from the jetting nozzle 30 is prevented. Accordingly, the efficiency of the cleaning and drying process can be improved.

On the other hand, if it is determined in step S17-2 that the temperature of the vapor area 25 is equal to or higher than the designated temperature T₀, the process goes to step S18. In step S18, the control apparatus 36 opens the valve 44 (see FIG. 4) so that the organic solvent 23 is started jetting from the jetting nozzles 30 onto the row bar 11. At the same time, the control apparatus 36 starts measuring a second process time, namely a jetting time of the organic solvent from the jetting nozzle 30.

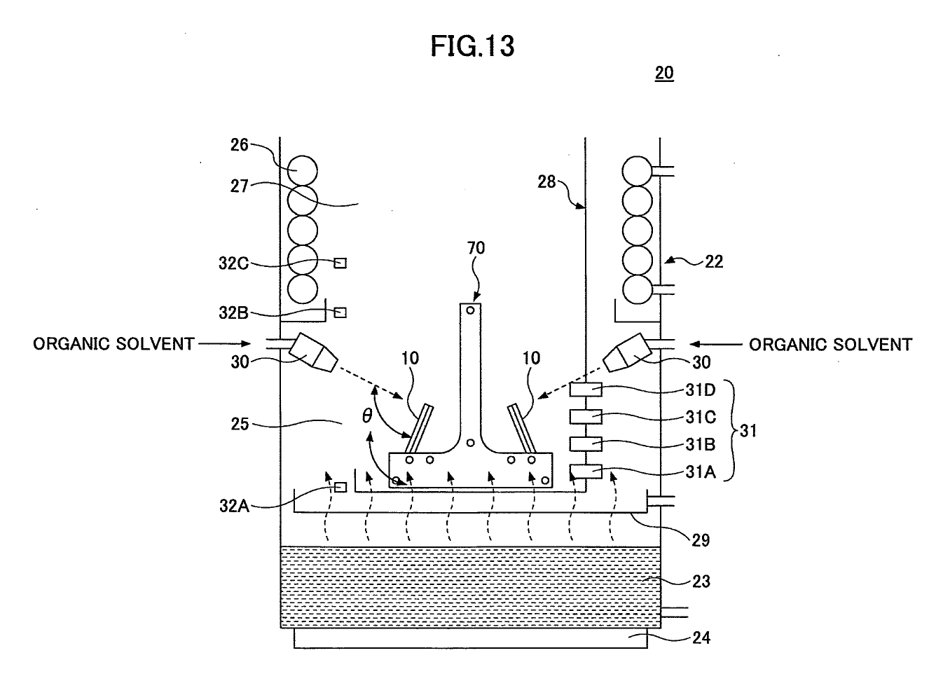

FIG. 13 shows a state where the organic solvent 23 is jetted from the jetting nozzle 30 onto the receiving case 10 (row bar 11). From the jetting nozzle 30, the organic solvent 23 (IPA) whose temperature is controlled to be approximately 20° C. is jetted onto the receiving case 10 (row bar 11) with an angle θ which is equal to or greater than 90 degrees. The jet flow rate of the organic solvent 23 is, for example, 1.4 L/s. Furthermore, in this example, as discussed above with reference to FIG. 8, the jetting nozzle 30 can be rotated. As discussed above with reference to FIG. 20, the jetting nozzle 30 can jet the organic solvent 23 in an elliptical shape. Therefore, it is possible to efficiently jet the organic solvent 23 onto the receiving case 10 (row bar 11).

The surface of the row bar 11 is cleaned by jetting the organic solvent 23 onto the receiving case 10 (row bar 11). In addition, since the temperature of the jetted organic solvent 23 is approximately 20° C., the row bar 11 whose temperature had been approximately 80° C. at the time of determining “YES” in step S17 is gradually cooled.

The control apparatus 36 detects the temperature of the row bar 11 with the temperature sensors 31A through 31D. The control apparatus 36 determines whether the temperature of the row bar 11 is the second temperature set in step S10, namely a temperature at which the droplets of the organic solvent 23 are generated on the surface of the row bar 11 (more specifically, approximately 24° C.). In addition, the control apparatus 36 has implemented this temperature detecting process and has determined whether the jetting time of the organic solvent 23 from the jetting nozzle 30 exceeds the designated time 2. Here, the “designated time 2” is a time obtained via experiment. The “designated time 2” is a time required for the temperature of the row bar 11 to become the second temperature after jetting from the jetting nozzle 30 is started. In this example, the designated time 2 is approximately 1 minute.

In this example, the temperature of the row bar 11 is equal to or higher than the second temperature (approximately 24° C.). While the second process time does not exceed the designated time 2, the jetting process of the organic solvent 23 from the jetting nozzle 30 in step S18 continues.

On the other hand, if it is determined that the temperature of the row bar 11 is equal to or lower than the second temperature (approximately 24° C.) and the second process time exceeds the designated time 1, the control apparatus 36 closes the valve 44 so that jetting of the organic solvent 23 from the jetting nozzle 30 stops.

In a state where the jet of the organic solvent 23 from the jetting nozzle 30 stops, the temperature of the row bar 11 is equal to or less than the second temperature. Therefore, the droplets of the organic solvent 23 can be generated on the surface of the row bar 11 again. Accordingly, the second cleaning and drying process of the row bar 11 is implemented in step S20. The control apparatus 36 starts measuring a third process time of the second cleaning and drying process at the same time when the jetting of the organic solvent 23 from the jetting nozzle 30 stops.

The process implemented by the second cleaning and drying process in step S20 is substantially the same as the first cleaning and drying process in step S16. In other words, the droplets of the organic solvent 23 condense on the surface of the row bar 11. The condensed organic solvent 23 falls down on the surface of the row bar 11 and the dirt on the surface of the row bar 11 flows down concurrently. Hence, the surface of the row bar 11 is cleaned. In addition, when the temperature of the row bar 11 is increased with the change of time, the droplets do not condense on the row bar 11 and the organic solvent 23 adhered on the surface of the row bar 11 is vaporized by heat. Thus, the surface of the row bar 11 is dried.

The control apparatus 36, in step 21-1, detects the temperature of the row bar 11 with the temperature sensors 31A through 31D and determines whether the temperature of the row bar 11 is the first temperature set in step S10, namely a temperature substantially equal to the temperature in the vapor area 25. In addition, the control apparatus 36 implements this temperature detecting process and determines whether the third process time after jetting of the organic solvent 23 is stopped exceeds the designated time 3. Here, the “designated time 3” is a time obtained via experiment. The “designated time 3” is a time required for the temperature of the row bar 11 to become the first temperature after jetting from the jetting nozzle 30 is stopped. In this example, the designated time 3 is approximately 14 minutes.

When “yes” is determined in step S21-1, the control apparatus 36 sends the process to step 21-2, where it is determined whether the temperature of the vapor area 25 measured by the temperature sensors 31A through 31D is equal to or higher than the designated temperature T₀. The “designated temperature T₀” here is the same as the designated temperature T₀ discussed with reference to step S17-2.

In step S21-2, where the temperature of the vapor area 25 is less than the designated temperature T₀, the organic solvent 23 has been resupplied from the circulation unit 35 into the cleaning and drying tank 22 by the resupplying process of the organic solvent 23, so that the temperature of the vapor area 25 is decreased and thereby the droplets of the organic solvent 23 can condense on the surface of the receiving case 10 (row bar 11) which is a cleaning and drying subject.

In this example, after the step 22, if the temperature of the vapor area 25 is less than the designated temperature T₀, the process is prevented taking out the receiving case 10 (row bar 11) from the vapor area 25. By implementing the process of step S21-2, it is possible to prevent generation of stain on the receiving case 10 (row bar 11) for which the cleaning process has been completed.

In other words, as shown in FIG. 20, the decrease of temperature of the vapor area 25 exists for a short period of time. The amount of the organic solvent 23 condensing on the surface of the receiving case 10 (row bar 11) for a short period of time is small so that the organic solvent 23 does not flow down at this time, unlike during the cleaning process time. Thus, if the receiving case 10, where the droplets of the organic solvent 23 are adhered, is taken out from the vapor area 25, the condensed organic solvent 23 may remain as the stains due to vaporization. On the other hand, in this example, if the temperature of the vapor area 25 is less than the designated temperature T₀, the process is prevented taking out the receiving case 10 (row bar 11) from the vapor area 25. Hence, It is possible to prevent generation of stains on the receiving case 10 (row bar 11).

If it is determined in step S21-2 that the temperature of the vapor area 25 is equal to or higher than the designated temperature T₀, the process goes to step S22. The control apparatus 36 controls driving the elevation driving apparatus 33 so as to raise the elevation stage 28 at the second velocity V2 set in step S10, for example, approximately 2.5 mm/s.

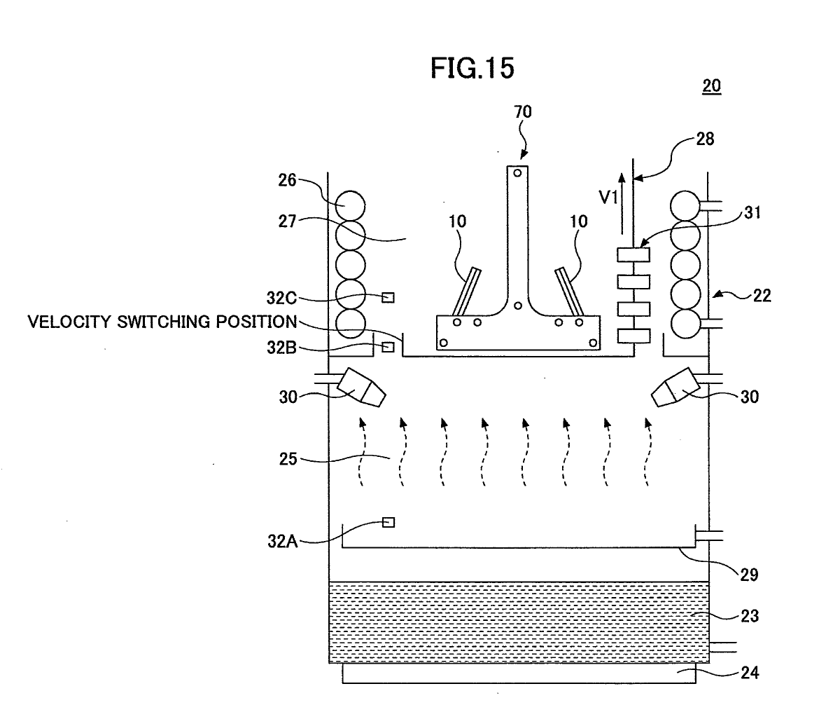

The control apparatus 36, based on the signal from the position sensor 32B, determines whether the elevating stage 28 reaches the velocity switching position in step S23. The control apparatus 36 raises the elevating stage 28 at the second velocity V2 until the elevating stage 28 reaches the velocity switching position. When the elevating stage 28 reaches the velocity switching position, in step S24, the control apparatus 36 switches the elevating speed of the elevating stage 28 to the first velocity V1. The first velocity V1 is, for example, approximately 9.5 mm/s. FIG. 15 shows the state where the elevating stage 28 is elevated so as to reach the velocity switching position.

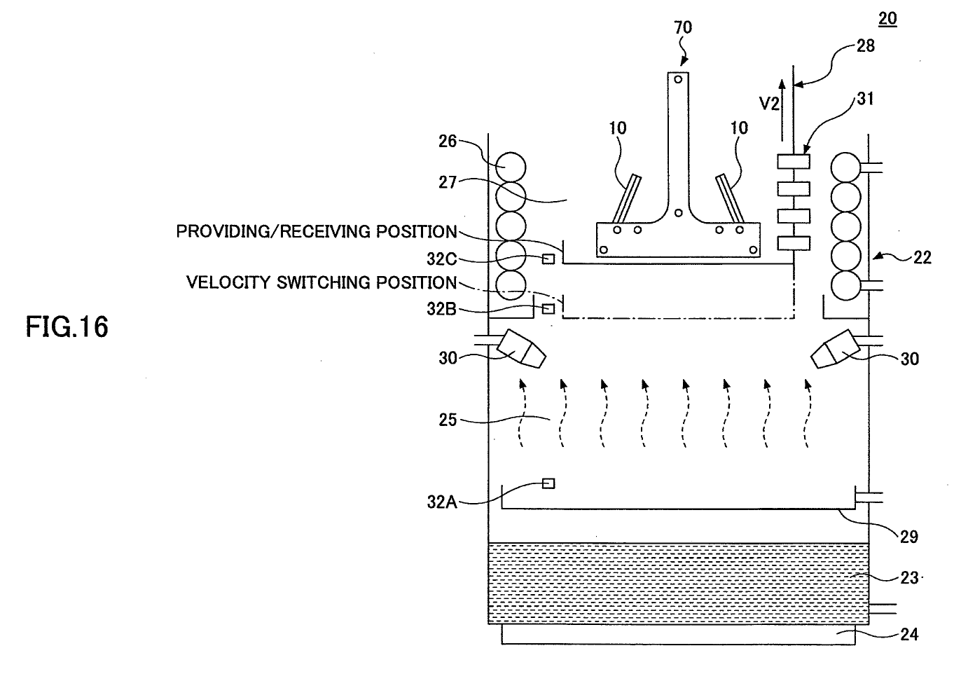

After that, the control apparatus 36 raises the elevating stage 28 at the first velocity V1 until the elevating stage 28 reaches the providing/receiving position. At the time when the elevating stage 28 reaches the providing/receiving position, all processes for cleaning and drying are completed. FIG. 16 shows the state where the elevating stage 28 has been moved to the providing/receiving position.

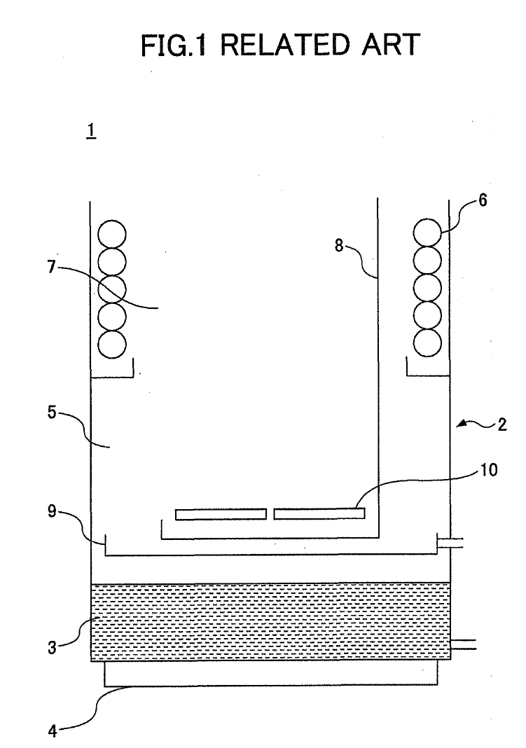

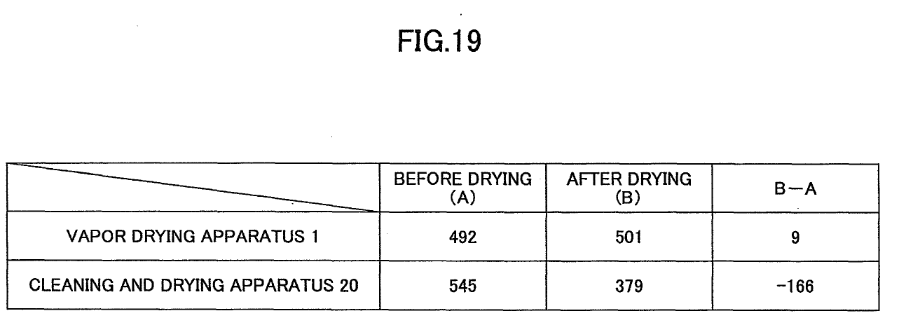

FIG. 19 shows a cleaning effect by the cleaning and drying apparatus 20 of this example, compared to a cleaning effect by the vapor drying apparatus 1 shown in FIG. 1. In this comparative example, cleaning and drying processes were applied to silicon wafers 5 inches in diameter by the cleaning and drying apparatus 20 and the vapor drying apparatus 1. After that, the number of contaminants having lengths equal to or longer than 0.2 μm on the wafer surface was counted by using a particle counter and is shown in FIG. 19.

As shown in FIG. 19, the number of the contaminants found in the case where the cleaning and drying apparatus 20 was used is smaller than the number of the contaminants found in the case where the vapor drying apparatus 1 was used. Accordingly, it is proved that the cleaning and drying qualities when the cleaning and drying apparatus 20 is used are higher than those when the vapor drying apparatus 1 is used.

In the above-discussed examples, an example where the first cleaning and drying process in step 16, the cleaning process by jetting the organic solvent 23 from the jetting nozzle 30 in step S18, and the first cleaning and drying process in step S20 are implemented only one time is discussed. However, each cleaning and drying process of step S16, step S18 and step S20 can be repeated. By repeating the cleaning and drying processes of step S16, step S18 and step S20, it is possible to further improve the cleaning and drying effect.

In addition, in this example, after the first cleaning and drying process step S16 is implemented, cleaning is implemented by jetting the organic solvent 23 in step S18. However, after the cleaning using the jet of the organic solvent 23 is implemented, the first cleaning and drying process may be implemented.

According to the embodiments of the present invention, in a case where the temperature of the vapor area is equal to or lower than the temperature at which the droplets of the organic solvent can condense on the surface of the cleaning and drying subject, driving of the install and uninstall apparatus stops. Accordingly, it is possible to prevent the cleaning and drying subject from being taken out from the vapor area in a state where stains due to condensation remain on the surface.

Although the invention has been described with respect to specific embodiments for a complete and clear disclosure, the appended claims are not to be thus limited but are to be construed as embodying all modifications and alternative constructions that may occur to one skilled in the art that fairly fall within the basic teachings herein set forth.

This patent application is based on Japanese Priority Patent Application No. 2007-298135 filed on Nov. 16, 2007, the entire contents of which are hereby incorporated herein by reference.

What is claimed is:

1. A cleaning and drying apparatus, comprising:
a cleaning and drying tank where an organic solvent is stored;
a resupplying part configured to resupply the organic solvent in the cleaning and drying tank when a storage amount of the organic solvent in the cleaning and drying tank is equal to or less than a designated value; and
a installing and uninstalling apparatus configured to install and uninstall a cleaning and drying subject in a vapor area where vapor of the organic solvent is generated;
wherein a cleaning process and a drying process for the cleaning and drying subject are implemented in the vapor area of the cleaning and drying apparatus,
wherein the cleaning and drying apparatus further includes
a temperature detecting part configured to detect a temperature of the vapor area; and
a first preventing part configured to prevent driving of the install and uninstall apparatus when the temperature of the vapor area is equal to or lower than a temperature at which droplets of the organic solvent can condense on a surface of the cleaning and drying subject.

2. The cleaning and drying apparatus as claimed in claim 1, further comprising:
a jetting part configured to jet an organic solvent the same as the organic solvent stored in the cleaning and drying tank from a jetting nozzle to the cleaning and drying subject; and
a second preventing part configured to prevent driving of the jetting part when the temperature of the vapor area is equal to or lower than the temperature at which the droplets of the organic solvent can condense on the surface of the cleaning and drying subject.

3. The cleaning and drying apparatus as claimed in claim 1,
wherein the temperature detecting part is a single one or more temperature sensors provided at a stage where the cleaning and drying subject is provided.

4. The cleaning and drying apparatus as claimed in claim 1,
wherein the install and uninstall apparatus includes a stage where the cleaning and drying subject is provided and an elevation driving apparatus configured to elevate the stage.

5. A cleaning and drying method, comprising:
a first step of cleaning and drying a cleaning and drying subject provided in a vapor area where vapor of an organic solvent is generated; and
a second step of taking out the cleaning and drying subject from the vapor area,
wherein transfer from the first step to the second step is prevented in a case where the temperature of the vapor area is equal to or lower than a temperature at which droplets of the organic solvent can condense on a surface of the cleaning and drying subject.

6. The cleaning and drying method as claimed in claim 5, further comprising:
a third step of jetting an organic solvent the same as the organic solvent used in the first step from a jetting nozzle to the cleaning and drying subject, after the first step is completed;
wherein transfer from the first step to the third step is prevented in a case where the temperature of the vapor area is equal to or lower than the temperature at which the droplets of the organic solvent can condense on the surface of the cleaning and drying subject.

7. The cleaning and drying method as claimed in claim 5,
wherein the temperature detecting part is a single one or more temperature sensors provided at a stage where the cleaning and drying subject is provided.
